(19) United States
(12) Patent Application Publication
(10) Pub. No.: US 2005/0129846 A1
(43) Pub. Date: Jun. 16, 2005

(54) Methods of preparing surface crosslinked superabsorbent-containing composites

(75) Inventors: William G. Reeves, Appleton, WI (US); Shannon K, Melius, Appleton, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/734,005

(22) Filed: Dec. 10, 2003

(51) Int. Cl. B05D 7/00

(52) U.S. Cl. 427/221

(57) ABSTRACT

Surface crosslinked superabsorbent-containing composites. More particularly, methods of treating the surface of composites containing particles of superabsorbent material.

### BACKGROUND

The present invention relates to surface crosslinked superabsorbent-containing composites. More particularly, the present invention relates to methods of treating the surface of composites containing particles of superabsorbent material.

Superabsorbent materials possess a number of attributes that make them attractive in many different applications. In particular, superabsorbent materials are capable of absorbing large quantities of liquids such as water and body exudates and of retaining such absorbed liquids under moderate pressures. These absorption characteristics make them especially suitable for use in disposable absorbent articles such as diapers, training pants, sanitary napkins, incontinent devices and the like. Typically, particles of superabsorbent material are disposed in and/or on webs of absorbent fibers in the absorbent core component of such disposable absorbent articles.

Many early superabsorbent processes produced particles of superabsorbent materials that may be assumed to be essentially uniformly crosslinked throughout the particle. One problem associated with the uniform or “bulk” crosslinked superabsorbent materials was their tendency to “gel block” when aqueous liquids were added to them or they were added to aqueous liquids. The surfaces of the massed particles would swell rapidly to form a soft, deformable layer. The resulting particle deformation and interparticle adhesion reduced interparticle porosity and limited the swelling rate of the superabsorbent mass to the diffusion rate of liquid through the partially swollen mass. Attempts to address this problem resulted in particles of superabsorbent material having a more highly crosslinked surface layer that is more rigid than its core. The shell of higher crosslink density provides a more rigid surface layer during swelling and minimizes the gel-blocking that would otherwise occur early in the swelling process. As a result, liquid can usually flow through the bed of particles to each particle of superabsorbent material, increasing the effective surface available for swelling and the apparent swelling rate.

Even with the use of surface crosslinked or “core-shell” superabsorbent materials, however, the likelihood of gel-blocking has increased as developers of disposable personal hygiene articles increase the concentration of superabsorbent material in their disposable absorbent articles. One approach to minimize the likelihood of gel-blocking has been to coat the particles of superabsorbent material with a layer of untreated fibers. While effective, such untreated fiber coatings have a tendency to be compacted between swelling particles of superabsorbent, limiting fluid penetration through the composite. This deficiency typically results in diminishing the effectiveness of the superabsorbent composite.

Another approach calls for coating particles of superabsorbent material with chemically stiffened fibers to form an absorbent composite. The stiffened fibers do not swell in water to the extent that untreated fibers do. The stiffened fibers also resist compression to a greater extent than untreated fibers. Existing interfiber channels or other avenues for liquid to flow through an absorbent structure formed from the fibers are, therefore, kept open to a greater extent by stiffened fibers than by untreated fibers. This approach, however, is limited at times due to the difficulties often encountered in bringing the stiffened fibers into sufficient contact with the superabsorbent particles and thus forming an effective absorbent composite. Moreover, fiber stiffening adds an additional process step along with its attendant complications and cost. Consequently, there remains a need for improved methods of preparing surface crosslinked superabsorbent-containing composites.

### SUMMARY

In response to the foregoing need, the present inventors undertook intensive research and development efforts that resulted in the discovery of novel methods of preparing surface crosslinked superabsorbent-containing composites. One version of the present invention discloses a method of preparing a surface crosslinked superabsorbent-containing composite. The method provides for introducing at least one particle of at least one coating material into a flowing gas stream. The flowing gas stream moves the coating material through a zone where an association agent and a crosslinking reagent are applied to the coating material. At least one particle of at least one superabsorbent material is introduced into the flowing gas stream. The flowing gas stream is maintained until the superabsorbent material is covered with at least a first layer of the coating material.

Another version of the present invention provides for the preparation of a surface crosslinked superabsorbent-containing composite wherein at least one particle of at least one coating material and at least one particle of superabsorbent material into a flowing gas stream. The flowing gas stream moves the superabsorbent material and the coating material through a zone where an association agent and a crosslinking reagent are applied to the superabsorbent material and the coating material. The flowing gas stream is maintained until the superabsorbent material is covered with at least a first layer of the coating material.

### DRAWINGS

The foregoing and other features and aspects of the present invention and the manner of attaining them will become more apparent, and the invention itself will be better understood by reference to the following description, appended claims and accompanying drawing, where:

FIG. 1 illustrates a representative fluidized bed coating apparatus.

### DESCRIPTION

The surface crosslinked superabsorbent-containing composites prepared according to a method of the present invention include at least one particle of superabsorbent material covered with at least one particle of coating material.

By “particle,” “particles,” “particulate,” “particulates” and the like, it is meant that a material is generally in the form of discrete units. The particles can include granules, pulverulents, powders or spheres. Thus, the particles can have any desired shape such as, for example, cubic, rod-like, polyhedral, spherical or semi-spherical, rounded or semi-rounded, angular, irregular, etc. Shapes having a large greatest dimension/smallest dimension ratio, like needles, flakes and fibers, are also contemplated for use herein. The use of “particle” or “particulate” may also describe an agglomeration including more than one particle, particulate or the like.

As used herein, the phrase “association”, “associated” and other similar terms are intended to encompass various configurations, including: those where at least a portion of the surface of at least one particle of a layer of coating material is in contact with a portion of the surface of at least one particle of superabsorbent material; and/or those where at least a portion of the surface of at least one particle of a layer of coating material is in contact with a portion of the surface of at least one other particle of a layer of coating material.

A wide variety of materials can be suitably employed as the superabsorbent material of the present invention. It is desired, however, to employ superabsorbent materials in particle form capable of absorbing large quantities of fluids, such as water, and of retaining such absorbed fluids under moderate pressures. It is even more desired to use relatively inexpensive and readily obtainable superabsorbent materials.

As used herein, “superabsorbent material,” “superabsorbent materials” and the like are intended to refer to a water-swellable, water-insoluble organic or inorganic material capable, under the most favorable conditions, of absorbing at least about 10 times its weight and, desirably, at least about 15 times its weight in an aqueous solution containing 0.9 weight percent of sodium chloride. Such materials include, but are not limited to, hydrogel-forming polymers which are alkali metal salts of: poly(acrylic acid); poly(methacrylic acid); copolymers of acrylic and methacrylic acid with acrylamide, vinyl alcohol, acrylic esters, vinyl pyrrolidone, vinyl sulfonic acids, vinyl acetate, vinyl morpholinone and vinyl ethers; hydrolyzed acrylonitrile grafted starch; acrylic acid grafted- starch; maleic anhydride copolymers with ethylene, isobutylene, styrene, and vinyl ethers; polysaccharides such as carboxymethyl starch, carboxymethyl cellulose, methyl cellulose, and hydroxypropyl cellulose; poly(acrylamides); poly(vinyl pyrrolidone); poly(vinyl morpholinone); poly(vinyl pyridine); and copolymers and mixtures of any of the above and the like. The hydrogel-forming polymers suitable for use in the present invention are generally available from various commercial vendors, such as, for example, The Dow Chemical Co., BASF or Stockhausen, Inc.

Suitably, the superabsorbent material is in the form of particles which, in the unswollen state, have maximum cross-sectional diameters ranging between about 100 and about 1,000 microns; desirably, between about 150 and about 800 microns; more desirably, between about 200 and about 650 microns; and most desirably, between about 300 and about 600 microns, as determined by sieve analysis according to American Society for Testing Materials Test Method D-1921. It is understood that the particles of superabsorbent material may include solid particles, porous particles, or may be agglomerated particles including many smaller particles agglomerated into particles falling within the described size ranges.

The superabsorbent-containing composites prepared according to the present invention also include at least a first layer of at least one particle of at least one coating material. In such an instance, the first layer of coating material is in association with and covering the superabsorbent material. The coating material of the first layer is desirably in particle form.

The superabsorbent-containing composites prepared according to the present invention may also include more than one layer of coating material. In such an instance, any subsequent layer of coating material is typically in association with and covering at least a portion of a preceding layer of coating material. The coating material of any subsequent layer is desirably in particle form.

Use of “cover,” “covers,” “covering” or “covered” with regard to coating material is intended to indicate that the coating material extends over the surface of the material being covered to the extent necessary to realize many of the advantages of the superabsorbent-containing composites prepared according to the present invention. For example, this includes situations where the coating material extends over no less than 5; alternatively, no less than 10; alternatively, no less than 20; alternatively, no less than 30; alternatively, no less than 40; alternatively, no less than 50; alternatively, no less than 60; alternatively, no less than 70; alternatively, no less than 80; alternatively, no less than 90; and finally, alternatively, no less than 95 percent of the surface of the material being covered. This also includes, for example, situations where the coating material extends over no more than 100; alternatively, no more than 95; alternatively, no more than 85; alternatively, no more than 75; alternatively, no more than 65; alternatively, no more than 55; alternatively, no more than 45; alternatively, no more than 35; alternatively, no more than 25; alternatively, no more than 15; and finally, alternatively, no more than 10 percent of the surface of the material being covered. Thus, the coating material may extend over no less than 5 up to no more than 100 percent of the surface of the material being covered; although the approximate percent of the surface being covered may vary according to, inter alia, the general design and intended use of the superabsorbent-containing composite. The term “surface” and its plural generally refer herein to the outer or the topmost boundary of an object.

A wide variety of natural and synthetic materials, in particulate form, can be employed as the coating material of the superabsorbent-containing composite. Suitable coating materials may therefore include adsorbent and/or absorbent material. It is, of course, desired to use coating materials that are inexpensive, readily available and safe—important attributes for a material used in the disposable absorbent articles described herein. Illustrative examples of coating material suitable for use in the present invention include particles of hydrophilic material. Examples of hydrophilic material suitable for use as coating material include, but are not limited to, cellulosic materials, both natural and synthetic, such as wood pulp and products made from it such as powdered cellulose, and non-woody cellulose materials such as cotton, linen, jute, abaca, ixtl and the like, and products made from them such as cotton linters and floc; regenerated cellulose such as rayon, cupram, lyocell and the like; and cellulose derivatives such as hydroxypropyl cellulose, hydroxyethyl cellulose, ethyl cellulose, cellulose acetate and the like. A particularly desired coating material is food grade alpha-cellulose powder. Also suitable for use as coating material are silicates, both natural and synthetic, such as precipitated silica, fumed silica, silicon dioxide, zeolites, clays, vermiculite, perlite and the like. Desirably, the particles of a suitable silicate coating material have a minimum diameter of 50 microns. Also found suitable for use as coating material are insoluble proteins such as texturized vegetable proteins (e.g., soy protein) and zein.

It should be noted that the present invention is not limited to the use of only one coating material, but can also include mixtures of two or more coating materials. Although hydrophilic materials have been indicated as being suitable for use as coating materials in the present invention, one skilled in the art would readily appreciate the possibility of treating the surfaces of hydrophobic materials by an appropriate known method to render the hydrophobic materials more or less hydrophilic. As previously indicated, the coating material is in particulate form; consequently, it is understood that the particles of coating material may include solid particles, porous particles, or may be an agglomeration of more than one particle of coating material.

To assist in (i) the association of the coating material with the superabsorbent material and (ii) attaining the desired degree of surface crosslinking, an association agent and a crosslinking reagent are applied to the appropriate material(s). In one instance, an association agent may be applied to the appropriate material(s) followed by the application of a crosslinking reagent to the appropriate material(s). Alternatively, a crosslinking reagent may be applied to the appropriate material(s) followed by the application of an association agent to the appropriate material(s). Still another alternative provides for the simultaneous application of an association agent and a crosslinking reagent to the appropriate material(s). For example, a mixture including an association agent and a crosslinking reagent may be formed. A suitable mixture of association agent and crosslinking reagent may include a variety of other materials so long as they do not interfere with the surface crosslinking described herein. For example, the mixture may comprise a solvent, such as water, an alcohol, acetone, or the like. The mixture is typically applied in liquid or semi-liquid form to the superabsorbent material and/or the coating material.

The term “applied”, as used in conjunction with the association agent and/or the crosslinking reagent, is intended to include situations where: at least a portion of the surface of at least one particle of superabsorbent material has an effective amount of association agent and/or crosslinking reagent on it to facilitate adherence, via mechanical and/or chemical bonding, of at least that portion of the surface of the superabsorbent material to a portion of the surface of at least one particle of coating material; at least a portion of the surface of at least one particle of coating material has an effective amount of association agent and/or crosslinking reagent on it to facilitate adherence, via mechanical and/or chemical bonding, of at least that portion of the surface of the coating material to a portion of the surface of at least one particle of superabsorbent material; and/or at least a portion of the surface of at least one particle of coating material has an effective amount of association agent and/or crosslinking reagent on it to facilitate adherence, via mechanical and/or chemical bonding, of at least that portion of the surface of the coating material to a portion of the surface of at least one other particle of coating material.

Desirably, the association agent and the crosslinking reagent are applied to the appropriate material(s) in an amount of no less than 1; alternatively, no less than 2; alternatively, no less than 3; alternatively, no less than 4; alternatively, no less than 5; alternatively, no less than 10; alternatively, no less than 15; alternatively, no less than 20; alternatively no less than 25; alternatively, no less than 30; alternatively, no less than 40; alternatively, no less than 50; alternatively, no less than 60; alternatively, no less than 70; alternatively, no less than 75; alternatively, no less than 80; alternatively, no less than 85; alternatively, no less than 90; alternatively, no less than 95; alternatively, no less than 96; alternatively, no less than 97; and finally, alternatively, no less than 98 percent, by weight of the superabsorbent-containing composite. The association agent and the crosslinking reagent may also be applied to the appropriate material(s) in an amount of no more than 99; alternatively, no more than 98; alternatively, no more than 97; alternatively, no more than 96; alternatively, no more than 95; alternatively, no more than 90; alternatively, no more than 85; alternatively, no more than 80; alternatively, no more than 75; alternatively, no more than 70; alternatively, no more than 60; alternatively, no more than 50; alternatively no more than 40; alternatively, no more than 30; alternatively, no more than 25; alternatively, no more than 20; alternatively, no more than 15; alternatively, no more than 10; alternatively, no more than 5; alternatively, no more than 4; alternatively, no more than 3; or finally, alternatively, no more than 2 percent, by weight of the superabsorbent-containing composite. Thus, the association agent and the crosslinking reagent may be applied to the appropriate material(s) in an amount ranging over no less than 1 up to no more than 99 percent, by weight of the superabsorbent-containing composite; although the approximate percent of the association agent and the crosslinking reagent may vary according to, inter alia, the general design and intended use of the superabsorbent-containing composite.

A mixture of association agent and crosslinking reagent suitable for use in the present invention is typically prepared by the formation of a liquid or semi-liquid capable of being generally uniformly atomized. In particular, a solution, dispersion or emulsion including at least one of the association agents and one of the crosslinking reagents identified herein may be prepared. Although the mixture may be applied as finely atomized droplets, it may also be applied to the selected material by any other method such as by spraying in liquid or semi-liquid form, spraying and blowing in the form of steam, and the like.

The selection of a particular association agent can be made by one skilled in the art and will typically depend upon the chemical composition of the materials to be maintained in association with one another. Desirably, the association agent is suitable for use in applications involving human contact. Thus, the association agent should be non-toxic and non-irritating to humans. Several types of association agent are capable of being employed in the present invention. Illustrative association agents suitable for use in various versions of the present invention include, for example: water; volatile organic solvents such as alcohols; aqueous solutions of film-forming materials such as dried milk, lactose, soluble soy protein, and casein; synthetic adhesives such as polyvinyl alcohol; and mixtures thereof. The presence of water in the association agent is particularly effective in predisposing the superabsorbent material to wetting.

When applied separately (i.e., not as a mixture), one of skill in the art will readily appreciate that the association agent is typically prepared by the formation of a liquid or semi-liquid capable of being generally uniformly atomized. In particular, a solution, dispersion or emulsion including at least one of the association agents identified herein may be prepared. Although the association agent may be applied as finely atomized droplets, it may also be applied to the selected material by any other method such as by spraying in liquid or semi-liquid form, spraying and blowing in the form of steam, and the like.

When used in conjunction with superabsorbent material, the phrases “crosslinked”, “crosslinking” and the like are intended to refer to any means for effectively rendering normally water-soluble materials substantially water insoluble but swellable. Such means can include, for example, physical entanglement, crystalline domains, covalent bonds, ionic complexes and associations, hydrophilic associations, such as hydrogen bonding, and hydrophobic associations or Van der Waals forces. When used in conjunction with coating material, the phrases “stiffening”, “crosslinked”, “crosslinking” and the like are intended to refer to a means for rendering the coating material more resistant to compression. Typically, the stiffening results from creation of physical and/or chemical bonds between moieties on the surface of the coating material. It is not unusual to find that crosslinking reagents suitable for surface crosslinking a superabsorbent may also crosslink or stiffen a coating material, providing further enhancement to the superabsorbent-containing composite.

Crosslinking reagents suitable for use in the present invention are desirably water soluble and include, but are not limited to, ethyleneglycol diglycidyl ether, aluminum acetate, aluminum sulfate, glycerol, ethylene carbonate, quaternary amines, polyhydric alcohols, glycidyl compounds, alkylene carbonates, silyl esters, tetramethoxy silane, and mixtures thereof.

One of skill in the art will readily appreciate that the crosslinking reagent is applied to the appropriate material(s) in an effective amount. That is, the crosslinking reagent is present in an amount sufficient to provide the desired degree of crosslinking to at least a portion of the intended surface. The exact amount of crosslinking reagent will, of course, depend on the specific crosslinking reagent employed. In general, the crosslinking reagent is typically present in an amount of no less than 0.001; alternatively, no less than 0.01; alternatively, no less than 0.1; alternatively, no less than 0.5; alternatively, no less than 1; alternatively, no less than 2; alternatively, no less than 3; alternatively, no less than 4; alternatively, no less than 5; alternatively, no less than 6; alternatively, no less than 7; alternatively, no less than 8; and finally, alternatively, no less than 9 weight percent, based on the total weight of the superabsorbent-containing composite. Moreover, the crosslinking reagent is typically present in an amount no more than 10; alternatively, no more than 9; alternatively, no more than 8; alternatively, no more than 7; alternatively, no more than 6; alternatively, no more than 5; alternatively, no more than 4; alternatively, no more than 3; alternatively, no more than 2; alternatively, no more than 1; alternatively, no more than 0.1; and finally, alternatively, no more than 0.01 weight percent, based on the total weight of the superabsorbent-containing composite. Thus, a crosslinking reagent may be present in an amount of no less than 0.001 up to no more than 10 percent, based on the total weight of the superabsorbent-containing composite; although the approximate weight percent of crosslinking reagent may vary according to, inter alia, the general design and intended use of the superabsorbent-containing composite. One of skill in the art will readily understand that the amount of crosslinking reagent applied will affect the degree or density of crosslinking that occurs. As such, a lesser amount of crosslinking reagent will generally result in less crosslinking, whereas a relatively greater amount of crosslinking reagent will result in more crosslinking.

The amount of crosslinking reagent applied depends on a variety of factors. For example, when an aluminum cation is the crosslinking reagent, if the aluminum cation is supplied in the form of aluminum chloride, a lower weight amount of aluminum chloride can be used than if the aluminum cation is supplied in the form of a hydrate of aluminum sulfate. This is because the molecular weight of aluminum sulfate is greater than that of aluminum chloride. In order to provide the equivalent number of aluminum ions for crosslinking, a greater weight of aluminum sulfate will be necessary (compared to aluminum chloride). One skilled in the art can easily experimentally determine the optimum amount of a given crosslinking reagent employed in surface crosslinking a given material.

When applied separately (i.e., not as a mixture), one of skill in the art will also readily appreciate that the crosslinking reagent may be prepared by the formation of a liquid or semi-liquid capable of being generally uniformly atomized. In particular, a solution, dispersion or emulsion including at least one of the crosslinking reagents identified herein may be prepared. Although the crosslinking agent may be applied as finely atomized droplets, it may also be applied to the selected material by any other method such as by spraying in liquid or semi-liquid form, spraying and blowing in the form of steam, and the like.

In the past, coating materials and superabsorbent materials have been separately crosslinked to obtain these benefits, then brought together to form an absorbent composite. However, it has now been found that this can be done in a single step. This constitutes a significant reduction in process complexity, as well as a reduction in manufacturing cost. In addition, the coating materials are now adhered to the surface of the superabsorbent, increasing the integrity of the superabsorbent-containing composite.

As used herein, the phrase “absorbent article” refers to devices which absorb and contain body fluids, and more specifically, refers to devices which are placed against or near the skin to absorb and contain the various fluids discharged from the body. The term “disposable” is used herein to describe absorbent articles that are not intended to be laundered or otherwise restored or reused as an absorbent article after a single use. Examples of such disposable absorbent articles include, but are not limited to: health care related products including ostomy products, surgical drapes, gowns, and sterilization wraps; personal care absorbent products such as feminine hygiene products, diapers, training pants, incontinence products and the like; as well as toweling and facial tissues.

Disposable absorbent articles such as, for example, many of the personal care absorbent products, typically include a fluid pervious topsheet, a liquid impervious backsheet joined to the topsheet and an absorbent core positioned between the topsheet and the backsheet. Disposable absorbent articles and components thereof, including the topsheet, backsheet, absorbent core and any individual layers of these components, generally have a body-facing surface and a garment-facing surface. As used herein, “body-facing surface” refers to that surface of the article or component which is intended to be worn toward or placed adjacent to the body of the wearer, while the “garment-facing surface” is on the opposite side and is intended to be worn toward or placed adjacent to the wearer's undergarments when the disposable absorbent article is worn.

The superabsorbent-containing composites prepared according to one of the methods of the present invention are suitable for use in a variety of disposable absorbent articles. In general, the superabsorbent-containing composites may be used in a manner similar to that in which other absorbent composites have been used: for example, in laminates, in relatively high density cores (i.e., compacted cores, calendered cores, densified cores, etc.), or in relatively low density cores (i.e., not compacted, for example, air-laid cores).

The superabsorbent-containing composites may be prepared in a manner similar to fluidized bed coating processes. In one version of such a method, at least one particle of a coating material is suspended in a fluidized bed coating apparatus that creates a strong upward current or stream of fluidizing gas, usually air, typically at an inlet temperature approximating that of room temperature. The strong upward current or stream of fluidizing gas moves the coating material upward until the coating material passes out of the upward stream and passes downward in a fluidized condition countercurrent to the upward stream of fluidizing gas. The coating material may re-enter the upward-moving stream of fluidizing gas. While in the upward-moving stream, the coating material passes through a zone where an association agent and a crosslinking reagent are applied to the coating material. After the association agent and the crosslinking reagent are applied to the coating material, at least one particle of superabsorbent material is introduced into the apparatus. A strong upward current or stream of fluidizing gas, usually air, optionally at an elevated inlet temperature (i.e., a temperature typically above room temperature), moves the coating material and the superabsorbent material upward until the coating material and the superabsorbent material pass out of the upward stream and pass downward in a fluidized condition countercurrent to the upward stream of fluidizing gas. The coating material and the superabsorbent material may re-enter the upward-moving stream of fluidizing gas until a superabsorbent-containing composite is formed. It is typically after the cassociation agent and the crosslinking reagent are applied that the coating material comes into association with the superabsorbent material to form a superabsorbent-containing composite. The superabsorbent-containing composite so formed includes at least one particle of superabsorbent material covered with at least a first layer of at least one particle of coating material. The coating material of the first layer is in association with and covering the surface of the superabsorbent material.

The superabsorbent-containing composites may also be prepared by another version of the method described herein. In this version, at least one particle of coating material and at least one particle of superabsorbent material are suspended in a fluidized bed coating apparatus that creates a strong upward current or stream of fluidizing gas, usually air, typically at an inlet temperature approximating that of room temperature. The strong upward current or stream of fluidizing gas moves both the coating material and the superabsorbent material upward until the coating material and the superabsorbent material pass out of the upward stream and pass downward in a fluidized condition countercurrent to the upward stream of fluidizing gas. The coating material and the superabsorbent material may re-enter the upward-moving stream of fluidizing gas. While in the upward-moving stream, the coating material and the superabsorbent material pass through a zone where an association agent and a crosslinking reagent are applied to both the coating material and superabsorbent material. After the association agent and crosslinking reagent are applied, the strong upward-moving stream of fluidizing gas, usually air, optionally at an elevated inlet temperature, moves the coating material and the superabsorbent material upward until the coating material and the superabsorbent material pass out of the upward stream and pass downward in a fluidized condition countercurrent to the upward stream of fluidizing gas. The coating material and the superabsorbent material may re-enter the upward-moving stream of fluidizing gas until a superabsorbent-containing composite is formed. It is typically after the association agent and the crosslinking reagent are applied that the coating material comes into association with the superabsorbent material to form a superabsorbent-containing composite. The superabsorbent-containing composite so formed includes at least one particle of superabsorbent material covered with at least a first layer of at least one particle of coating material. The coating material of the first layer is in association with and covering the surface of the superabsorbent material.

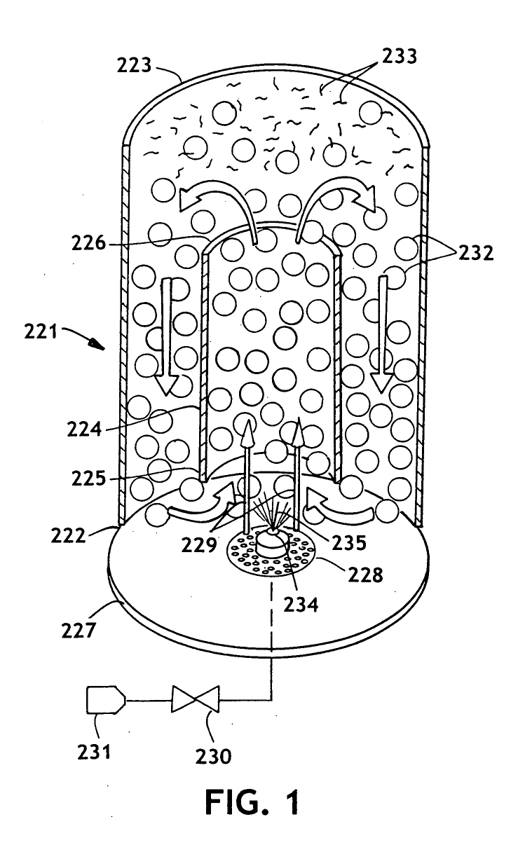

Typically, a fluidized bed coating apparatus similar to that illustrated in FIG. 1 can be utilized to form the superabsorbent-containing composites. Referring to FIG. 1, a generally vertically-mounted, generally cylindrical chamber (221) is open at chamber proximal end (222) and closed at chamber distal end (223). The chamber (221) is optionally provided with an inner chamber (224) that has a diameter less than that of the chamber. The inner chamber (224) is open at both inner chamber proximal end (225) and inner chamber distal end (226). The chamber proximal end (222) is fitted with a plate (227) that has a porous area (228) that generally matches the diameter of the inner chamber (224). The inner chamber (224) is positioned a distance above the plate (227) and is generally aligned along the vertical axis of the chamber (221). Through the porous area (228) is provided an upward current or stream (229) of fluidizing gas, usually air, typically at an inlet temperature approximating that of room temperature, such as from a valve (230) from a source of compressed gas (231). The upward-moving stream (229) of fluidizing gas generally flows through the inner chamber (224) by entering through the inner chamber proximal end (225) and exiting through the inner chamber distal end (226). As described in one of the previously mentioned versions of the process, at least one particle of coating material (233) is introduced into the chamber (221). The upward-moving stream (229) of fluidizing gas is adjusted so as to provide a fluid-like flow to the coating material (233). The upward-moving stream (229) of gas moves the coating material (233) upward until the coating material passes out of the upward stream and passes downward in a fluidized condition countercurrent to the upward-moving stream of fluidizing gas. The coating material (233) may re-enter the upward-moving stream (229) of fluidizing gas. While in the upward-moving stream, the coating material passes through a zone where, in this version, a mixture (235) (which includes an association agent and a crosslinking reagent) is applied to the coating material (233). This zone is generally located in the vicinity of a sprayer means (234) positioned near the center of the plate (227). After the mixture (235) is applied to the coating material (233), at least one particle of superabsorbent material (232) is introduced into the chamber (221). If necessary, the upward-moving stream (229) of gas is adjusted so as to provide a fluid-like flow to the superabsorbent material (232) and the coating material (233). After introduction of the superabsorbent material (232), the inlet temperature of the upward-moving stream (229) of fluidizing gas is optionally elevated to a temperature in excess of room temperature. The cyclic flow of the superabsorbent material (232) and the coating material (233) is generally allowed to continue in the chamber (221) until the coating material comes into association with the superabsorbent material to form a superabsorbent-containing composite. The superabsorbent-containing composite is then recovered or removed from the chamber (221). The superabsorbent-containing composite so formed includes at least one particle of superabsorbent material covered with at least a first layer of at least one particle of coating material. The coating material of the first layer is in association with and covering the surface of the superabsorbent material.

In the event it is necessary to heat the superabsorbent-containing composite to effect crosslinking, the superabsorbent-containing composite may remain in the apparatus and subject to the strong upward current or stream of fluidizing gas at an elevated temperature to effect crosslinking on at least a portion of the surface of a superabsorbent-containing composite. The temperature of any such heat treatment is desirably no less than 25; alternatively, no less than 30; alternatively, no less than 40; alternatively, no less than 50; alternatively, no less than 60; alternatively, no less than 70; alternatively, no less than 80; alternatively, no less than 90; alternatively, no less than 100; alternatively, no less than 125; alternatively, no less than 150; alternatively, no less than 175; alternatively, no less than 200; alternatively, no less than 225; alternatively, no less than 250; alternatively, no less than 275; alternatively, no less than 300; alternatively, no less than 325; alternatively, no less than 350; and finally, alternatively, no less than 375° C. Moreover, the temperature of any such heat treatment is desirably no more than 400; alternatively, no more than 375; alternatively; no more than 350; alternatively, no more than 330; alternatively, no more than 325; alternatively, no more than 300; alternatively, no more than 275; alternatively, no more than 250; alternatively, no more than 225; alternatively, no more than 200; alternatively, no more than 175; alternatively, no more than 150; alternatively, no more than 125; alternatively, no more than 100; alternatively, no more than 90; alternatively, no more than 80; alternatively, no more than 70; alternatively, no more than 60; alternatively, no more than 50; alternatively, no more than 40; and finally, alternatively, no more than 30° C. Thus, any such heat treatment will desirably range between no less than 25 up to no more than 400° C.; although the approximate temperature of any such heat treatment may vary according to, inter alia, the general design and intended use of the superabsorbent-containing composite. It should be noted, however, that the temperature of any such heat treatment should not exceed a temperature that would cause decomposition of the superabsorbent-containing composite or any material (for example, the cellulose portion(s) of any coating will typically decompose at about 230° C.) included in the superabsorbent-containing composite. One of skill in the art will readily appreciate that the time and temperature of heat treatment are chosen, considering the reactivity of the crosslinking reagent, to give the desired end-use properties. Although versions of the method have been described herein as heat treating a superabsorbent-containing composite in the apparatus, the heat treating of a superabsorbent-containing composite to effect crosslinking could be accomplished either in the apparatus or out of the apparatus according to any of a number of other suitable heat treating processes known to those skilled in the art. One of skill in the art will also appreciate that crosslinking may be effected free of any such heat treatment.

The fluidized bed coating process of the present invention is relatively mild in its effect on the superabsorbent material being brought into intimate association with the coating material and is therefore less damaging to the microstructure of the superabsorbent material as compared to other processes. Although discussed in terms of being formed according to a fluidized bed coating process, the superabsorbent-containing composites may also be formed using a variety of other processes incorporating, for example, a V-shell blender or other apparatus that is relatively mild in its effect on the superabsorbent material.

While a variety of apparatuses may be used in forming the superabsorbent-containing composites described herein, it is believed that a fluidized bed coating apparatus may be the optimal apparatus. This is due to a fluidized bed coating apparatus allowing for relatively precise control of temperature. In particular, a fluidized bed coating apparatus may be run at relatively high temperatures for relatively brief periods of time thus minimizing the likelihood of decomposition of the superabsorbent-containing composite or any material included in the superabsorbent-containing composite. This is particularly beneficial when relatively high temperatures are necessary to effect a desired level of crosslinking on at least a portion of the surface of a superabsorbent-containing composite.

Depending on the intended use of a superabsorbent-containing composite, it may be desired to add one or more additional layers of coating material to a superabsorbent-containing composite. Any additional layer of coating material is added in generally the same manner as is a first layer of coating material according to the at least one of the process embodiments described herein.

It is desired that a superabsorbent-containing composite prepared according to the present invention has a weight ratio, based on the total weight of the superabsorbent material and the coating material in the superabsorbent-containing composite, of superabsorbent material to coating material of from about 45:55 to about 95:5; alternatively, from about 60:40 to about 80:20; and finally, alternatively, from about 65:35 to about 70:30.

### EXAMPLES

The following Examples describe various versions of the invention. Other versions within the scope of the claims herein will be apparent to one skilled in the art from consideration of the specification or practice of the invention as disclosed herein. It is intended that the specification, together with the Examples, be considered exemplary only, with the scope and spirit of the invention being indicated by the claims which follow the Examples.

The superabsorbent utilized in each of the following examples was, a homogeneously (i.e., uniformly) crosslinked, polyacrylate superabsorbent material. A suitable material would be ST-10, a superabsorbent material commercially available from The Dow Chemical Co., Midland, Mich. The superabsorbent-containing composite(s) of each of the following examples were prepared in a fluidized bed at The Coating Place, Verona, Wis. The initial fluidization and coating occurred at a temperature between 14 and 23° C. Some examples were further heat treated while being fluidized to effect the crosslinking of the superabsorbent.

### Example 1

The coating material utilized in this example was EXCEL 110, a food grade alpha-cellulose powder commercially available from Functional Foods, Elizabethtown, N.J. The combination association agent/surface crosslinking reagent used was a 1 weight % aluminum sulfate aqueous solution prepared from Aluminum Sulfate, hydrate, 98% (Al₂(SO₄)₃*xH2O, where x=14 to 18, commercially available from Sigma-Aldrich, St. Louis, Mo. Approximately 286 g of the superabsorbent material and approximately 143 g of the coating material were added to a fluidized bed coating apparatus. While the coating material and the superabsorbent were being fluidized, approximately 77 g of the 1 weight % aluminum sulfate aqueous solution were added to the process. Fluidizing continued for approximately 5 minutes and the superabsorbent-containing composite was collected. Fluidization and coating were performed at a temperature between 17 and 22° C.

### Example 2

The coating material utilized in this example was EXCEL 110, a food grade alpha-cellulose powder commercially available from Functional Foods, Elizabethtown, N.J. The combination association agent/surface crosslinking reagent used was a 1 weight % aluminum sulfate aqueous solution prepared from Aluminum Sulfate, hydrate, 98% (Al₂(SO₄)₃*xH2O, where x=14 to 18, commercially available from Sigma-Aldrich, St. Louis, Mo. Approximately 143 g of the coating material were added to a fluidized bed coating apparatus. While the coating material was being fluidized, approximately 77 g of the 1 weight % aluminum sulfate aqueous solution were added to the process. After the aluminum sulfate solution was added, approximately 286 g of superabsorbent material were added to the process. Fluidizing continued for approximately 5 and the superabsorbent-containing composite was collected. Fluidization and coating were performed at a temperature between 16 and 22° C.

### Example 3

The coating material utilized in this example was Zeofree 5175B, a granulated, precipitated silica commercially available from J. M. Huber, Havre de Grace, Md. The combination association agent/surface crosslinking reagent used was a 1 weight % aluminum sulfate aqueous solution prepared from Aluminum Sulfate, hydrate, 98% (Al₂(SO₄)₃*xH2O, where x=14 to 18, commercially available from Sigma-Aldrich, St. Louis, Mo. Approximately 500 g of the superabsorbent material and approximately 75 g of the coating material were added to a fluidized bed coating apparatus. While the coating material and the superabsorbent were being fluidized, approximately 134 g of the 1 weight % aluminum sulfate aqueous solution were added to the process. Fluidizing continued for approximately 5 minutes and the superabsorbent-containing composite was collected. Fluidization and coating were performed at a temperature between 16 and 22° C.

### Example 4

The coating material utilized in this example was Zeofree 5175B, a granulated, precipitated silica commercially available from J. M. Huber, Havre de Grace, Md. The combination association agent/surface crosslinking reagent used was a 1 weight % aluminum sulfate aqueous solution prepared from Aluminum Sulfate, hydrate, 98% (Al₂(SO₄)₃*xH2O, where x=14 to 18, commercially available from Sigma-Aldrich, St. Louis, Mo. Approximately 75 g of the coating material were added to a fluidized bed coating apparatus. While the coating material was being fluidized, approximately 134 g of the 1 weight % aluminum sulfate aqueous solution were added to the process. After the aluminum sulfate solution was added, approximately 500 g of superabsorbent material were added to the process. Fluidizing continued for approximately 5 minutes and the superabsorbent-containing composite was collected. Fluidization and coating were performed at a temperature between 14 and 23° C.

### Example 5

The coating material utilized in this example was EXCEL 110, a food grade alpha-cellulose powder commercially available from Functional Foods, Elizabethtown, N.J. The combination association agent/surface crosslinking reagent used was a 4 weight % Kymene aqueous solution prepared from Kymene 557LX, commercially available from Hercules, Inc., Wilmington, Del. Approximately 286 g of the superabsorbent material and approximately 143 g of the coating material were added to a fluidized bed coating apparatus. While the coating material and the superabsorbent were being fluidized, approximately 74 g of the 4% Kymene aqueous solution were added to the process. Fluidizing continued for approximately 5 minutes and the superabsorbent-containing composite was collected. Fluidization and coating were performed at a temperature between 16 and 23° C. The fluidized bed apparatus was later heated to about 150° C. The superabsorbent-containing composite previously made in this example was reintroduced into the fluidized bed coating apparatus and heated for about 7 minutes. When the outlet air temperature was approximately 99° C., the run was considered complete and the superabsorbent-containing composite was collected.

### Example 6

The coating material utilized in this example was EXCEL 110, a food grade alpha-cellulose powder commercially available from Functional Foods, Elizabethtown, N.J. The combination association agent/surface crosslinking reagent used was a 4% weight Kymene aqueous solution prepared from Kymene 557LX, commercially available from Hercules, Inc., Wilmington, Del. Approximately 143 g of the coating material were added to a fluidized bed coating apparatus. While the coating material was being fluidized, approximately 74 g of the 4 weight % Kymene aqueous solution were added to the process. After the Kymene solution was added, approximately 286 g of superabsorbent material were added to the process. Fluidizing continued for approximately 5 minutes and the superabsorbent-containing composite was collected. Fluidization and coating were performed at a temperature between 16 and 22° C. The fluidized bed apparatus was later heated to about 150° C. The superabsorbent-containing composite previously made in this example was reintroduced into the fluidized bed coating apparatus and heated for about 3 minutes. When the outlet air temperature was approximately 113° C., the run was considered complete and the superabsorbent-containing composite was collected.

### Example 7

The coating material utilized in this example was EXCEL 110, a food grade alpha-cellulose powder commercially available from Functional Foods, Elizabethtown, N.J. The combination association agent/surface crosslinking reagent used was a 4 weight % ethylene carbonate solution prepared from Ethylene Carbonate, commercially available from Acros Organics, Fairlawn, N.J. Approximately 286 g of the superabsorbent material and approximately 143 g of the coating material were added to a fluidized bed coating apparatus. While the coating material and the superabsorbent were being fluidized, approximately 74 g of the 4 weight % ethylene carbonate solution were added to the process. Fluidizing continued for approximately 5 minutes and the superabsorbent-containing composite was collected. Fluidization and coating were performed at a temperature between 17 and 22° C. The fluidized bed apparatus was later heated to about 150° C. The superabsorbent-containing composite previously made in this example was reintroduced into the fluidized bed coating apparatus and heated for about 6.6 minutes. When the outlet air temperature was approximately 101° C., the run was considered complete and the superabsorbent-containing composite was collected.

### Example 8

The coating material utilized in this example was EXCEL 110, a food grade alpha-cellulose powder commercially available from Functional Foods, Elizabethtown, N.J. The combination association agent/surface crosslinking reagent used was a 4 weight % ethylene carbonate solution prepared from Ethylene Carbonate, commercially available from: Arcos Organics, Fairlawn, N.J. Approximately 143 g of the coating material were added to a fluidized bed coating apparatus. While the coating material was being fluidized, approximately 74 g of the 4 weight % ethylene carbonate solution was added to the process. After the ethylene carbonate solution was added, approximately 286 g of superabsorbent material were added to the process. Fluidizing continued for approximately 5 minutes and the superabsorbent-containing composite was collected. Fluidization and coating were performed at a temperature between 16 and 22° C. The fluidized bed apparatus was later heated to about 150° C. The superabsorbent-containing composite previously made in this example was reintroduced into the fluidized bed coating apparatus and heated for about 3 minutes. When the outlet air temperature was approximately 107° C., the run was considered complete and the superabsorbent-containing composite was collected.

### Example 9

The coating material utilized in this example was Zeofree 5175B, a granulated, precipitated silica commercially available from J. M. Huber, Havre de Grace, Md. The combination association agent/surface crosslinking reagent used was a 5 weight % glycerine solution prepared from Glycerin USP, commercially available from Humco Holding Group, Inc., Texarkana, Tex. Approximately 65 g of the coating material were added to a fluidized bed coating apparatus. While the coating material was being fluidized, approximately 34 g of the 5 weight % glycerin solution were added to the process. After the glycerin solution was added, approximately 260 g of superabsorbent material were added to the process. Fluidizing continued for approximately 5 minutes and the superabsorbent-containing composite was collected. Fluidization and coating were performed at a temperature between 14 and 23° C. (Note: the materials of this example were not heated to crosslink; however, it is believed that they could have been heated to crosslink.)

In view of the above, it will be seen that the several advantages of the invention are achieved and other advantageous results attained.

As various changes could be made in the foregoing methods without departing from the scope of the invention, it is intended that all matter contained in the above description and shown in the accompanying drawing shall be interpreted as illustrative and not in a limiting sense.

1. A method of preparing a surface crosslinked superabsorbent-containing composite, the method comprising:
(a) introducing at least one particle of at least one coating material into a flowing gas stream, the flowing gas stream moving the coating material through a zone where an association agent and a crosslinking reagent are applied to the coating material;
(b) introducing at least one particle of at least one superabsorbent material into the flowing gas stream; and
(c) maintaining the flowing gas stream until the superabsorbent material is covered with at least a first layer of the coating material.

2. A surface crosslinked superabsorbent-containing composite prepared according to the method of claim 1.

3. The method of claim 1, wherein the flowing gas stream comprises air.

4. The method of claim 3, further comprising (d) heating the flowing gas stream to an elevated temperature sufficient to effect crosslinking on at least a portion of the surface of the superabsorbent-containing composite.

5. The method of claim 1, wherein the coating material comprises a hydrophilic material.

6. The method of claim 5, wherein the coating material comprises a cellulosic material.

7. The method of claim 5, further comprising (d) heating the flowing gas stream to an elevated temperature sufficient to effect crosslinking on at least a portion of the surface of the superabsorbent-containing composite.

8. A surface crosslinked superabsorbent-containing composite prepared according to the method of claim 4.

9. The method of claim 1, wherein the coating material comprises a silicate.

10. The method of claim 9, further comprising (d) heating the flowing gas stream to an elevated temperature sufficient to effect crosslinking on at least a portion of the surface of the superabsorbent-containing composite.

11. A surface crosslinked superabsorbent-containing composite prepared according to the method of claim 10.

12. A method of preparing a surface crosslinked superabsorbent-containing composite, the method comprising:
(a) introducing at least one particle of at least one coating material into a flowing gas stream;
(b) introducing at least one particle of at least one superabsorbent material into the flowing gas stream, the flowing gas stream moving the superabsorbent material and the coating material through a zone where an association agent and a crosslinking reagent are applied to the superabsorbent material and the coating material; and
(c) maintaining the flowing gas stream until the superabsorbent material is covered with at least a first layer of the coating material.

13. A surface crosslinked superabsorbent-containing composite prepared according to the method of claim 12.

14. The method of claim 12, wherein the flowing gas stream comprises air.

15. The method of claim 14, further comprising (d) heating the flowing gas stream to an elevated temperature sufficient to effect crosslinking on at least a portion of the surface of the superabsorbent-containing composite.

16. The method of claim 12, wherein the coating material comprises a hydrophilic material.

17. The method of claim 16, wherein the coating material comprises a cellulosic material.

18. The method of claim 16, further comprising (d) heating the flowing gas stream to an elevated temperature sufficient to effect crosslinking on at least a portion of the surface of the superabsorbent-containing composite.

19. A surface crosslinked superabsorbent-containing composite prepared according to the method of claim 15.

20. The method of claim 12, wherein the coating material comprises a silicate.

21. The method of claim 20, further comprising (d) heating the flowing gas stream to an elevated temperature sufficient to effect crosslinking on at least a portion of the surface of the superabsorbent-containing composite.

22. A surface crosslinked superabsorbent-containing composite prepared according to the method of claim 21.
